(19) United States
(12) Patent Application Publication
(10) Pub. No.: US 2020/0226605 A1
(43) Pub. Date: Jul. 16, 2020

(54) SYSTEMS AND METHODS FOR ACCOUNT MONITORING AND TRANSACTION VERIFICATION

(71) Applicant: Capital One Services, LLC, McLean, VA (US)

(72) Inventors: Austin WALTERS, Savoy, IL (US); Anh TRUONG, Champaign, IL (US); Mark WATSON, Urbana, IL (US); Reza FARIVAR, Champaign, IL (US); Vincent PHAM, Champaign, IL (US); Fardin Abdi Taghi ABAD, Champaign, IL (US); Jeremy GOODSITT, Champaign, IL (US)

(21) Appl. No.: 16/247,816

(22) Filed: Jan. 15, 2019

(51) Int. Cl. G06Q 20/40; G06Q 20/32; G06F 21/55

(52) U.S. Cl. CPC G06Q 20/4016; G06F 21/552; G06Q 20/3221

(57) ABSTRACT

Embodiments of the present disclosure provide systems and methods for account monitoring and transaction verification are described. In an embodiment, a tracking application can identify a transaction and collect details regarding the transaction from an account history and collect device information, including device movement data, for a client device associated with the owner of the account. The tracking application can analyze the device information alone and compare the device information to the transaction information, in order to determine consistency and identify any indications that the transaction can be potentially unauthorized, potentially fraudulent, or otherwise potentially illegitimate.

### FIELD OF THE INVENTION

This disclosure relates to account security and transaction verification, and more specifically, to systems and methods for account monitoring and transaction verification.

### BACKGROUND

Electronic commerce is a large and growing part of the global economy. The growth of electronic commerce is driven in part by the proliferation of personal computing devices, such as smart phones, smart watches, laptop computers, and tablets. As these devices become more prevalent consumers frequently carry one or more of them at all times, even when the consumer is involved in an activity that does not require such a device. The ready availability of these devices creates demand for access to data, including data for account management, bill payment, and online shopping and other services, and encourages consumers to demand easy and secure access to data while at home, outside the home, and on mobile devices. In response to these demands, organizations that host or manage user accounts are continuously monitoring user accounts and account activity in order to improve services, provide consumers with new services and new options, and maintain the overall consumer experience.

In addition, securing user accounts and protecting data is growing in importance, particularly for protecting financial information and maintaining the integrity of user accounts. Despite large investments in developing, implementing, and maintaining security measures, fraud and theft continue to cause damage. Any organization handling or storing sensitive data, including financial accounts assets, risks liability for, and incurs significant costs to avoid, breaches or data losses. Fraudulent transactions and other security breaches can cause financial and reputational losses, erode consumer confidence in a business, and may attract significant public attention.

The location and movement of a personal computing device may be a determinant in identifying and reducing fraud by, e.g., determining if a device owned by a consumer is near a point of sale or other location at which a transaction involving an account associated with the consumer occurred. Many techniques employ geolocation to make this determination, however, geolocation data may only be available if Global Positioning System (GPS) tracking or location tracking is turned on, and can therefore be easily avoided. In other instances, a GPS signal may not be available due to technical issues, such as insufficient signal strength, and this may reduce or preclude the collection of location data as well.

Accordingly, there are increasingly important needs to monitor consumer accounts, verify the integrity of transactions, and detect potential fraud or theft, without reliance on GPS data or location tracing.

### SUMMARY

Therefore, it is an object of this disclosure to describe systems and methods for account monitoring and transaction verification. Various embodiments describe systems and methods for monitoring and verifying user activity, including the investigation of potentially unauthorized or fraudulent actions.

Embodiments of the present disclosure provide a transaction monitoring system comprising: a server containing a user account database storing transaction information associated with at least one account; an application configured to obtain device information from a client device, wherein the device information includes data relating to movement of the client device; a processor, wherein upon receipt of a communication based on activity associated with the at least one account, the processor is configured to: access device information from the application, the device information including movement data of a predetermined period of time before receipt of the communication; retrieve transaction information relating to the activity associated with the at least one account; compare the transaction information to the device information to identify at least one discrepancy between the transaction information and the movement data; and generate a notification based on the at least one discrepancy.

Embodiments of the present disclosure provide a method of monitoring transactions comprising: recognizing a transaction involving an account associated with a user, the transaction having details of the transaction; obtaining device information from a client device associated with the user, the device information including at least data relating to movement of the client device; executing a query of a transaction database to obtain transaction information relating to previous transactions, wherein the query is based at least in part on the details of the transaction; comparing the transaction information to the device information and a movement profile and identifying at least one discrepancy between the transaction information and the device information and the movement profile; sending a notification to the client device requesting that the user classify the transaction as authorized or unauthorized.

Embodiments of the present disclosure provide an account monitoring application installed on a first client device associated with a user, the application configured to: access account data relating to an account associated with the user; determine whether a transaction involving the account has taken place; and upon determining that a transaction involving the account has taken place, the application configured to: collect device information from at least one of a gyroscope, an accelerometer, a pedometer, a magnetometer, a linear acceleration sensor, an attitude sensor, and a transmitter on the client device relating to the movement of the client device for a predetermined period of time prior to the transaction and for a predetermined period of time after the transactions; send device information and account data to a server; display a request for the user to classify the transaction as authorized or unauthorized; and notify the server of the user's classification.

### BRIEF DESCRIPTION OF THE DRAWINGS

FIG. 1 illustrates an account monitoring and transaction verification system according to an example embodiment.

FIG. 2 illustrates a client device according to an example embodiment.

FIG. 3 illustrates a method of locating a client device according to an example embodiment.

FIG. 4 illustrates a flow chart for a method of verifying a transaction according to an example embodiment.

FIGS. 5A-5D illustrate a series of application user interfaces according to example embodiments.

FIGS. 6A-6D illustrate a series of web browser user interfaces according to example embodiments.

### DETAILED DESCRIPTION OF EXAMPLE EMBODIMENTS

One aspect of the present disclosure is to provide data access control, and systems and methods to maintain data access control, such as flagging accounts so additional products or services can be offered or provided, or to present a mechanism through which legitimate users can re-establish account security.

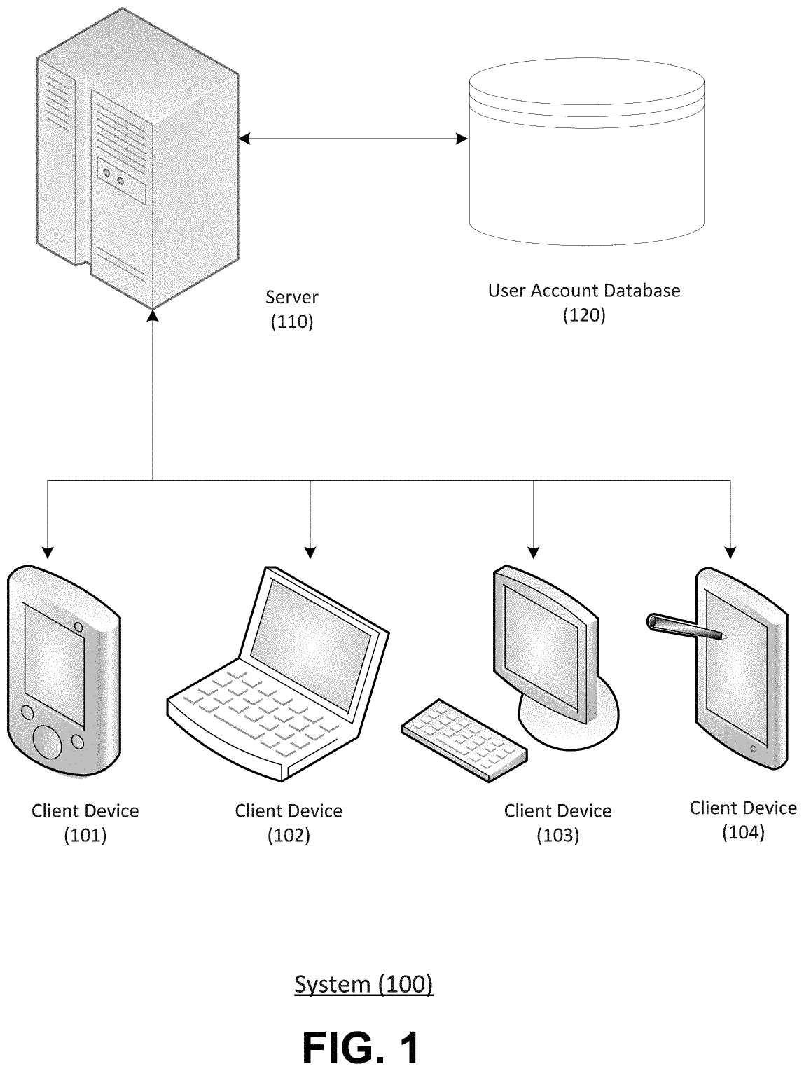

FIG. 1 illustrates data access control and account management system 100 according to an example embodiment. In this embodiment, the system includes a plurality of client devices 101, 102, 103, 104, a server 110, and a user account database 120. As shown in FIG. 1, client device 101 may be a smartphone, client device 102 may be a laptop, client device 103 may be a desktop computer, and client device 104 may be a tablet computer. Client devices 101-104 are not limited to these examples, and may be any combination of smartphones, laptop computers, desktop computers, tablet computers, personal digital assistants, thin clients, fat clients, Internet browsers, smart cards, or customized software applications. It is further understood that the client devices may be of any type of device that supports the communication and display of data and user input. While the example embodiment illustrated in FIG. 1 shows client devices 101-104, the present disclosure is not limited to a specific number of client devices, and it is understood that the system 100 may include a single client device or multiple client devices.

The server 110 can be a dedicated server computer, such as bladed servers, or may be personal computers, laptop computers, notebook computers, palm top computers, network computers, mobile devices, or any processor-controlled device capable of supporting the system 100. While FIG. 1 illustrates a single server 110, it is understood that other embodiments can use multiple servers or multiple computer systems as necessary or desired to support the users and can also use back-up or redundant servers to prevent network downtime in the event of a failure of a particular server.

The server 110 can contain a user account database 120. The user account database 120 can be a relational or non-relational database, or a combination of more than one database or other storage device that may not necessarily be characterized as a database. In an embodiment, the user account database 120 can be stored by server 110, alternatively the user account database 120 can be stored remotely, such as in another server, on a cloud-based platform, or in any storage device that is in data communication with server 110. The user account database can include information relating to one or more user accounts, including without limitation purchase history, purchase time, purchase amount, goods or services purchased, purchase location, purchaser identification, merchant or seller identification, and merchant or seller location. While FIG. 1 illustrates a single user account database 120, it is understood that other embodiments can use multiple databases as necessary or desired to perform the function described herein and can also use back-up or redundant databases to prevent downtime in the event of a database failure.

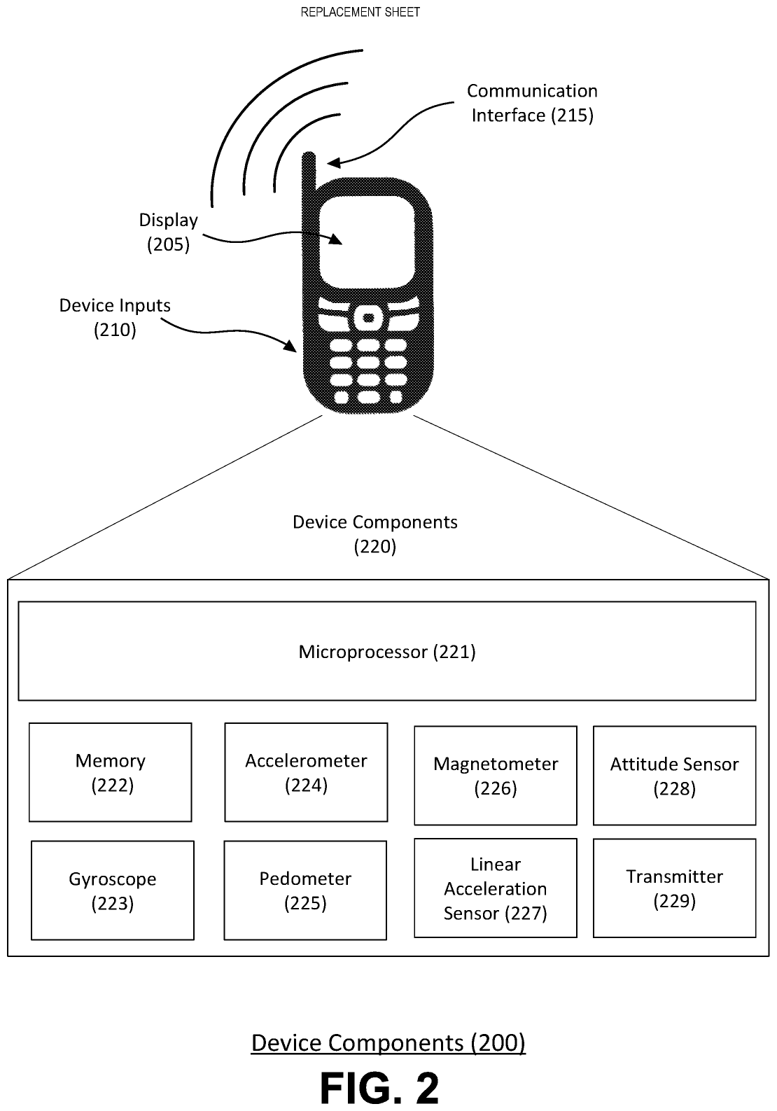

FIG. 2 illustrates a client device 200 according to an example embodiment. Client device 200 is depicted as a cellular telephone in FIG. 2, but it is understood that client device 200 can be any of the client devices described above with reference to FIG. 1. As shown in FIG. 2, client device 200 can include a display 205, device inputs 210, a communication interface 215, and device components 220. Device components 220 can include a microprocessor 221, memory 222, a gyroscope 223, an accelerometer 224, a pedometer 225, a magnetometer 226, a linear acceleration sensory 227, an attitude sensor 228, and a transmitter 229.

The display 205 can be any type of device for presenting visual information such as a computer monitor, a flat panel display, and a mobile device screen, including liquid crystal displays, light-emitting diode displays, plasma panels, and cathode ray tube displays. The device inputs 210 can include any device for entering information into the client devices that is available and supported by the client device 200, such as a touch-screen, keyboard, mouse, cursor-control device, touch-screen, microphone, digital camera, video recorder, or camcorder. These devices may be used to enter information and interact with the client device 200 and by extension with the systems described herein.

The communication interface 215 can include wired or wireless data communication capability. These capabilities may support data communication with a wired or wireless communication network, including the Internet, a cellular network, a wide area network, a local area network, a wireless personal area network, a wide body area network, any other wired or wireless network for transmitting and receiving a data signal, or any combination thereof. This network may include, without limitation, telephone lines, fiber optics, IEEE Ethernet 902.3, a wide area network, a local area network, a wireless personal area network, a wide body area network or a global network such as the Internet. The client device 200 can also support a short-range wireless communication interface, such as near field communication, radio-frequency identification, and Bluetooth, through communication interface 215, along with radio transmissions.

As shown in FIG. 2, the device components 220 can include a microprocessor 221. The microprocessor 221 can include a processor and associated processing circuitry, and can contain additional components, including processors, memories, error and parity/CRC checkers, data encoders, anticollision algorithms, controllers, command decoders, security primitives and tamperproofing hardware, as necessary to perform the functions described herein.

The memory 222 can be a read-only memory, write-once read-multiple memory or read/write memory, e.g., RAM, ROM and EEPROM, and the client device 200 can include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programmed many times after leaving the factory. It may also be read many times.

The gyroscope 223 can measure data relating to the movement of the client device 220, such as the angular velocity and orientation of the client device 200. The gyroscope 223 can collect the data it measures for storage in the memory 222.

In an embodiment, the gyroscope 223 can be a rotary gyroscope, a vibrating structure gyroscope, an optical gyroscope, or other known type of gyroscope. For example, the gyroscope 223 can be a microelectromechanical systems (MEMS) gyroscope. The client device 200 can include one or more gyroscopes as necessary to perform the functions described herein.

The accelerometer 224 can measure data relating to the acceleration of the client device 200. In an embodiment, the accelerometer 224 can perform axis-based motion sensing. The accelerometer 224 can collect the data it measures for storage in the memory 222.

In an embodiment, the accelerometer 224 can be a triple axis accelerometer. The accelerometer can be a digital, MEMS-based accelerometer, a surface micromachined capacitive accelerometer, a micromachined piezoelectric resistive accelerometer, a capacitive spring mass system base accelerometer, an electromechanical servo accelerometer, a high temperature accelerometer, a magnetic induction accelerometer, thermal accelerometer, a triaxial accelerometer, a piezoelectric accelerometer, or other known type of accelerometer. The client device 200 can include one or more accelerometers as necessary to perform the functions described herein.

The pedometer 225 can measure data relating to the movement of a client device 200 carried by a user. In an embodiment, the pedometer 225 can measure the movement of a client device 200 held by a user, whether held in hand, in a pocket, or otherwise. For example, upon calibration for step size, the pedometer can estimate the distance traveled by a user by counting the steps taken.

In an embodiment, the pedometer 225 can be a mechanical motion sensor combined with counting software, a MEMS inertial sensor, a spring-levered pedometer, a piezo-electric pedometer, an accelerometer chip pedometer, or other known type of pedometer. The pedometer 225 can apply one-axis, two-axis, or three-axis accelerometer. In an embodiment, the pedometer 225 can operate in conjunction with the accelerometer 224 or utilize independent hardware. The client device 200 can include one or more pedometers as necessary to perform the functions described herein.

The magnetometer 226 can measure data relating to the orientation of the client device 200. The magnetometer 226 can function as a compass within the client device 200 and can measure the direction of an ambient magnetic field. For example, the magnetometer 226 can measure data relating to the orientation of the client device 200 relative to the magnetic north pole of Earth. The magnetometer 226 can also measure magnetic field strength. The magnetometer 226 can collect the data it measures for storage in the memory 222.

In an embodiment, the magnetometer 226 can be an MEMS magnetometer, a vector magnetometer, a scalar magnetometer, a coil magnetometer, a magnetoresistive sensor, a magnetorestrictive sensor, and other known type of magnetometer. The client device 200 can include one or more magnetometers as necessary to perform the functions described herein.

The linear acceleration sensor 227 can measure data relating to the acceleration effect, excluding the effect of gravity, of the movement of the client device 200. In an embodiment, the linear acceleration sensor can derive data from the accelerometer 224. The linear acceleration sensor 227 can collect the data it measures for storage in memory 222.

In an embodiment, the linear acceleration sensor 227 employs a three-axis accelerometer and applies a low-pass filter on the accelerometer data to approximate the effect of gravity. Alternatively, the linear acceleration sensor 227 can utilize a gyroscope or a magnetometer to isolate the effect of gravity. The linear acceleration sensor 227 can operate in conjunction with the gyroscope 223, accelerometer 224, and magnetometer 226, or can employ independent hardware. The client device 200 can include one or more linear acceleration sensors as necessary to perform the functions described herein.

The attitude sensor 228 can measure data relating to the orientation of the client device 200. The attitude sensor 228 can function as a relative attitude sensor or as an absolute attitude sensor. In an embodiment, the attitude sensor 228 can measure the pitch, roll, and yaw angles of the client device 200. The attitude sensor 228 can collect the data it measures for storage in the memory 222.

In an embodiment, the attitude sensor 228 can be a gyroscope, a MEMS gyroscope, a motion reference unit, a horizon sensor, an orbital gyrocompass, a sun sensor, an earth sensor, a magnetometer, or other known type of attitude sensor. The attitude sensor 228 can function in conjunction with the gyroscope 223 or the magnetometer 226, or utilize independent hardware. The client device 200 can include one or more attitude sensors as necessary to perform the functions described herein.

The transmitter 229 can be any component with wired or wireless communication capability. The transmitter 229 can measure data relating to signal strength and voice or data transmission. The transmitter 229 can collect the data it measures for storage in the memory 222.

In an embodiment, the transmitter 229 can be any component with wired or wireless data communication capability compatible with the communication interface 215. For example, the transmitter can support voice or data communication over a cellular network, the Internet, a wide area network, a local area network, a wireless personal area network, a wide body area network, a radio network, a short-range communication interface such as near-field communication, radio-frequency identification, and Bluetooth, and any other wired or wireless network for transmitting and receiving a communication signal, or any combination thereof. The transmitter 229 can function in conjunction with the communication interface 215, or utilize independent hardware. The client device 200 can include one or more transmitters as necessary to perform the functions described herein.

The device components 220 can collect data relating to the movement and operation of the client device 200, and for purposes of this disclosure, this data is referred to as device information. It is understood that this term can refer to the data collected from one of the device components 220, all of the device components 220, and a combination thereof. It is further understood that this term can refer to all of the data collected by one or more of the device components 220 or a portion thereof. Further, while the device components 220 are illustrated in FIG. 2 as entirely contained within the client device 200, the present disclosure is not limited there to. It is understood that the device components 220 can be contained in one or more devices, or operate as stand-alone devices, and in these cases, the device components 220 can be configured to communicate with client device 200. For example, the microprocessor 221 and memory 222 can be contained in the client device 200, the gyroscope 223 can be contained in a separate device, such as a smart card, the accelerometer 224 can be configured as a stand-alone device, and the pedometer 225 can be contained another device, such as a wearable device. Thus, the systems and methods of the present disclosure can obtain data from multiple devices, in various combinations, and is not limited to the collection of data by a single device.

In an example of data collection, data collected by the gyroscope 223, the accelerometer 224, and the magnetometer 226 can be used to determine movement and orientation of the client device 200. In some embodiments, the location of the client device 200 can be determined from this information. As another example, the pedometer 225, accelerometer 224, and magnetometer 226 can be used to determine the location of the client device 200. As a further example, the gyroscope 223 can measure angular velocity and orientation data of the client device 200 that, in combination with the signal strength data measured by the transmitter 229, can be used to determine the location of the client device 200.

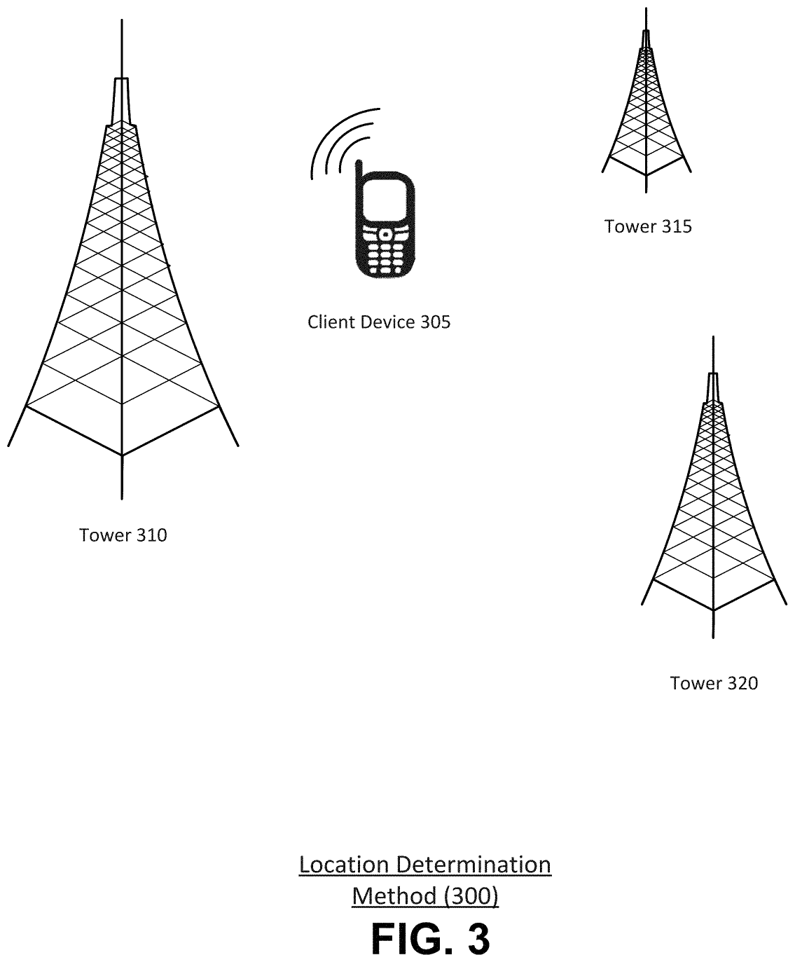

FIG. 3 illustrates of a location determination method 300 according to an example embodiment. As shown in FIG. 3, the client device 305 can be located within range of three towers used for communication, towers 310, 315, 320, each at a different location. FIG. 3 does not depict towers 310, 315, 320 to scale, but it is understood that each tower is at a different location relative to each other and to the client device 305.

In an embodiment, towers 310, 315, 320 can be each transmitting a cellular signal. With knowledge of the location of the towers, through e.g., each of towers 310, 315, 320 broadcasting its location or by other means, the location of the client device 305 can be calculated. In an embodiment, the location of the client device 305 can be triangulated. The accuracy of the location determination can be improved by assessing the strength of the cellular signal received from each tower, under the assumption that signal strength increases as proximity to a tower increases and decreases when proximity decreases.

In another embodiment, the towers 310, 315, 320 can transmit a data signal, e.g., a WiFi signal, a cellular data signal, other data signals. The transmitter of a client device can search for data signals sent by towers 310, 315, 320, or data routers associated with towers 310, 315, 320, and calculate the distance of each tower from the client device 305. The distance can be calculated based on, for example, WiFi address (e.g., basic service set identification (BSSID)) broadcast location, signal strength, or a combination thereof. In an embodiment, the distance can be calculated by triangulation.

In the embodiments illustrated in FIG. 3, the accuracy of the location determination can be improved through the collection and analysis of movement data measured by a gyroscope, such as the angular velocity and orientation of the client device. In addition to the use of a gyroscope, data from one or more other device components, e.g., an accelerometer, a pedometer, a magnetometer, a linear acceleration sensor, and an attitude sensor, can be used to further improve the location data.

It is understood that device components can be used in other methods of determining the location of the client device, and those methods are within the present disclosure.

In an embodiment, the location determination can be calculated with reference to a last known location of the user. For example, if the client device has Global Positioning System (GPS) functionality, the last known location the client device obtained via GPS can be utilized. However, it is understood that the embodiments of the present disclosure do not determine location using GPS. Instead, embodiments of the present disclosure provide methods of determining the location of the client device without GPS.

In an embodiment, the device information can be assembled and analyzed by a tracking application. The tracking application can be installed locally on the client device, or can be installed remotely at a location in data communication with the client device, such as server (e.g., server 110 illustrated in FIG. 1), a network location, or a cloud-based platform. The tracking application can instruct the device components to begin collecting device information or, alternatively, the device components can continuously collect device information. For example, the device components can collect device information for storage in memory on a rolling basis and the device information can be retained for a predetermined period of time. The tracking application can perform this analysis by preparing a probability map or by performing other calculations relating to the user's likely locations.

The tracking application can have access to the user account database. However, a user can be required to login or otherwise authenticate himself or herself before accessing specific account information relating to one or more accounts associated with that user. Once this is completed, the tracking application can access information relating to those accounts contained in the user account database. In an embodiment, the location of a recently completed transaction can be incorporated into the location determination. For example, the device information collected by the device components can be analyzed with reference to the location of the previously completed transaction.

In an embodiment, the device information can be stored in the user account database, in a separate database, or in a combination of one or more databases. The device information can be stored locally or at a remote location in data communication with the client device. Regardless of the location and nature of storage, the device information can be stored such that it is readily accessible by the tracking application.

Using the device information and the account information, the tracking application can perform a variety of account monitoring functions. For example, the tracking application can recognize the client device as entering in the vicinity of a merchant or store at which a prior transaction listed in the account information occurred. With this recognition, the tracking application can generate a notification informing the user that the merchant or store is nearby, reminding the user of the previous transaction, or presenting a promotional offer or discount.

As another example, the tracking application can alert the user of a merchant or store that offers a transaction that is similar to a prior transaction. As above, the tracking application can generate a notification informing the user that the merchant or store is nearby or presenting a promotional offer or discount.

In addition, the tracking application can perform transaction verification and fraud deterrence functions. For example, the tracking application can monitor the activity on an associated account and detect when a transaction involving the account occurs. Once detected, the tracking application can analyze the device information collected by one or more device components to determine whether the transaction is legitimate or potentially fraudulent.

For example, if the account activity shows a new transaction taking place at a merchant location, the tracking application can determine whether the client device was at the merchant's location, or at least in the vicinity of the merchant's location, at the time the transaction took place. If so, the transaction can likely be considered legitimate. If not, the transaction could be potentially fraudulent, and further actions can be taken to verify the transaction. The authentication procedure can include the submission of additional identifying information relating to the user or the performance of a specific task, where the information or task is different from the submitted login credentials. The further actions can include sending a notification, e.g., a text message or telephone call to a telephone number associated with the account, an email to an address associated with an account, a notification to the client device or to a different client device associated with the account. Upon receipt of the notification, the user can approve or deny the transaction. In addition, the notification can be accompanied by a requirement that the user authenticate himself or herself prior to approving or denying the transaction. For example, the user may be required to, without limitation, answer one or more security questions, enter a security code, answer or act upon a message sent to a registered email account, scan an identification document, and submit a form of biometric identification. Upon successful completion of this authentication procedure, the user can be permitted to review and approve or deny the transaction. If the user approves the transaction, the transaction can stand on the account, and if the user denies the transaction, the transaction can be withdrawn, rescinded, or otherwise precluded from processing. In addition, the account can be frozen so other transactions cannot take place, restricted such that any future transaction requires the user's approval, and the transaction can be reported to a fraud investigation entity.

Embodiments of the present disclosure are not limited to a certain type of account. It is understood that the present disclosure includes, without limitation, financial accounts (e.g., savings, checking, credit card, debit card, mortgage, loan, brokerage, retirement, cryptocurrency accounts), service accounts (e.g., utilities and home security accounts), entertainment accounts (e.g., video streaming, gaming and entertainment), accounts used for holding commercially valuable content (e.g., data backups, music and video content, and digital archives), and others.

For example, if the associated account is an entertainment account, e.g., a video streaming service, the tracking application can determine whether the client device is in the vicinity of the registered address for the account prior to initiating a video stream or other service. If not, the client device can present an authentication and/or authorization before content is delivered. As another example, if the associated account is service account, e.g., a home security account, the tracking application could verify the location of the client device in the event an alarm was activated, so the likelihood of unnecessary protective actions can be reduced. In this example, an alarm triggered when the client device is in the vicinity of the home could be accidental, and the client device can be sent a verification that, if answered within a set period of time, can stop an alarm from activating.

While the foregoing embodiments involve the use of device information to determine location, it is understood that the present disclosure is not limited thereto. The present disclosure includes account monitoring and transaction verification embodiments based on collections and analysis of device information for purposes other than determining a location. As a result of not being reliant on GPS or other location tracking methods, these embodiments may overcome the difficulties associated with these technologies, e.g., varying signal strength and the ability of users to disable or otherwise avoid location monitoring, as noted above.

For example, the tracking application can analyze device information collected from a client device around the time of the transaction to determine whether the client device was in a position to complete the transaction. If device information collected from the accelerometer, linear acceleration sensor, and/or pedometer shows the portable client device is moving rapidly, such as if it is being carried by a user that is walking briskly, jogging, running, or driving. In view of this, the tracking application can conclude that the transaction can potentially have been requested by a user different than the user associated with the client device, or a device other than the user's client device, which increases the likelihood that the transaction is potentially fraudulent. In this situation, a request for verification can be sent to one or more client devices associated with the user.

In addition, the interface used to place a transaction can assist in this determination. For example, for a transaction made at a store kiosk when the device information indicates the client device is moving rapidly at that time, the tracking application can consider the transaction to be potentially fraudulent and verification can be required. As another example, if the account information can indicate a purchase made via a mobile web site or mobile application at a time when the device information indicates rapid movement, the tracking application can consider the purchase to be potentially fraudulent. Similarly, if the gyroscope and/or magnetometer indicate the client device is being held or moved in a manner inconsistent with placing a transaction, the likelihood of a fraudulent transaction can be higher and verification can be required.

Device information can be collected for analysis prior to, and after, a transaction as well. In some examples, the device information collected leading up to, or following, a transaction can be indicative of a potentially fraudulent transaction and increase the need for verification. In a specific example, a user's account may be involved in a transaction at retail store at a shopping mall. The device information collected from, e.g. the accelerometer, linear acceleration sensor, and/or pedometer, can be analyzed for movement patterns consistent with presence at a shopping mall, e.g., a period of walking before and after a purchase, a period of driving before and after a purchase, and slow movements consistent with browsing within stores. If these indicators are found, the likelihood that the transaction is fraudulent can be lower and verification can be considered unnecessary. In contrast, if the device information does not contain those indicators, then the likelihood that a transaction is fraudulent can be higher and verification can be required. If the user's account is involved in a transaction online, however, the same indicators can show a higher likelihood of potential fraud, because a lower level of movement can be expected for online transactions.

As another example, a user's account may be involved in a transaction at a cinema, and in this example the device information can be analyzed for consistency with presence at a cinema, e.g., slight movement immediately before and after the transaction, followed by a long period of little or no movement can indicate the user is seated and watching a movie. If these indicators are found, the likelihood that the transaction is fraudulent can be lower and verification can be considered unnecessary, and the absence of these indicators can demonstrate the opposite. As another example, a user's account may be involved in a transaction at an amusement park, where device information collected before and after the transaction may indicate periods of walking and standing in line. Further, device information collected by, e.g., the gyroscope, the attitude sensor, the accelerometer, and the linear acceleration sensor, can show rapid movement and changes in position and orientation indicative of riding a roller coaster, a Ferris wheel, or other amusement rides. This device information can be consistent with the user's presence in an amusement park, and reduce the likelihood that a transaction with a vendor at the amusement park is fraudulent. However, if the user is engaged in a transaction with a different vendor, e.g., an online vendor or a merchant not located at the amusement park, then this device information could indicate a higher likelihood that the transaction fraudulent.

In addition to using the device information collected before and after a transaction to determine whether that transaction is fraudulent, the collected data can be analyzed and aggregated into a movement profile. The movement profile can include the data collected by each device component, and the analysis can include associating the collected data with time, transactions, events, and users. If a transaction is found to be consistent with the movement profile, the transaction can be considered legitimate. Alternatively, if the transaction is found to be inconsistent with the movement profile, the transaction can be considered potentially illegitimate and verification can be required.

In some examples, the movement profile can include data collected with reference to merchant type and transaction type. For example, the movement profile can aggregate data collected before and after one or more transactions involving a particular merchant, a particular type of transaction, transactions occurring at a particular location, transactions involving a particular account.

In some examples, the movement profile can include data collected with reference to time. For example, the movement profile can aggregate data collected before and after one or more transactions occurring on a particular day, month, or year, within a particular range of dates, on weekdays, weekends, holidays, or any period of time.

In some examples, the movement profile can include data collected from transactions occurring within a particular geography, or involving one or more parties located within a particular geography. For example, the movement profile can include data collected with respect to the limits of a city, within a zip code, within a range of a particular address or known location.

In some examples, the movement profile can include data collected from transactions involving one or more parties known to have been involved in previous transactions identified as fraudulent.

The aggregated movement data can be analyzed and compared against future transactions to determine whether the future transactions may be potentially fraudulent and require additional verification. In some examples, the aggregated data can be applied to a more general category of transactions, in order to allow for a broader application of the collected movement data. Exemplary categories include, without limitation, a particular category of merchants, a particular category of transactions, particular time periods, and a group of locations or geographic ranges,

In some examples, a movement profile can be created using device information collected solely from transactions involving one account. However, it is understood that the present disclosure is not limited thereto, and movement profiles can be created with data taken from a plurality of accounts. Further, the accounts can be selected for inclusion in the movement profile based on various reasons, including without limitation, similarity of users associated with each account, similarity in transactions, geographic similarity, and other reasons.

The foregoing analyses performed by the tracking application can be made in context of device information collected with respect to other transactions. In an embodiment, the tracking application can access account information, which can include device information collected at the time of a transaction. Upon the involvement of the account in a similar, or duplicative, transaction (or multiple transactions), the tracking application can compare the device information collected from the client device to the device information in the account information for the similar or duplicative transaction(s). If the tracking application identifies discrepancies between the two sets of collected device information, the most recent transaction can be considered to require verification.

In an embodiment, the tracking application can capture device information for one or more of the device components as soon as a transaction is detected in the account information. If, for example, the device components are collecting information continuously and retaining this information on a rolling basis and/or for a set period of time, the tracking application can obtain the information collected prior to, as well as at the time of and subsequent to, the transaction.

In an embodiment, this analysis can be informed by transactions made by other users. For example, the tracking application can have access to the device information collected in the account information relating to similar or duplicative transactions made by other users. This data can be reported by a tracking application on the devices of other users or collected by the third party point-of-sale devices that participated in the transaction. For example, a third party point-of-sale device can provide data regarding, e.g., the payment method, payment device, transaction time, and transaction location, and any device information collected through the device components of the third party point-of-sale device. The data collected by the third-party point-of-sale device can be stored in the user account database, in a separate database, or in a combination of one or more databases. The third-party point-of-sale device data can be stored locally or at a remote location in data communication with the client device. Regardless of the location and nature of storage, the third-party point-of-sale data can be stored such that it is readily accessible by the tracking application.

In some examples, the tracking application can continuously capture device information for one or more of the device components, and some or all of this information can be stored locally on the client device by the tracking application, or transmitted for storage at a remote location at a remote location in data communication with the client device. Further, the data collected by the third party point-of-sale devices can be also be transmitted for storage, either on the client device or at a remote location.

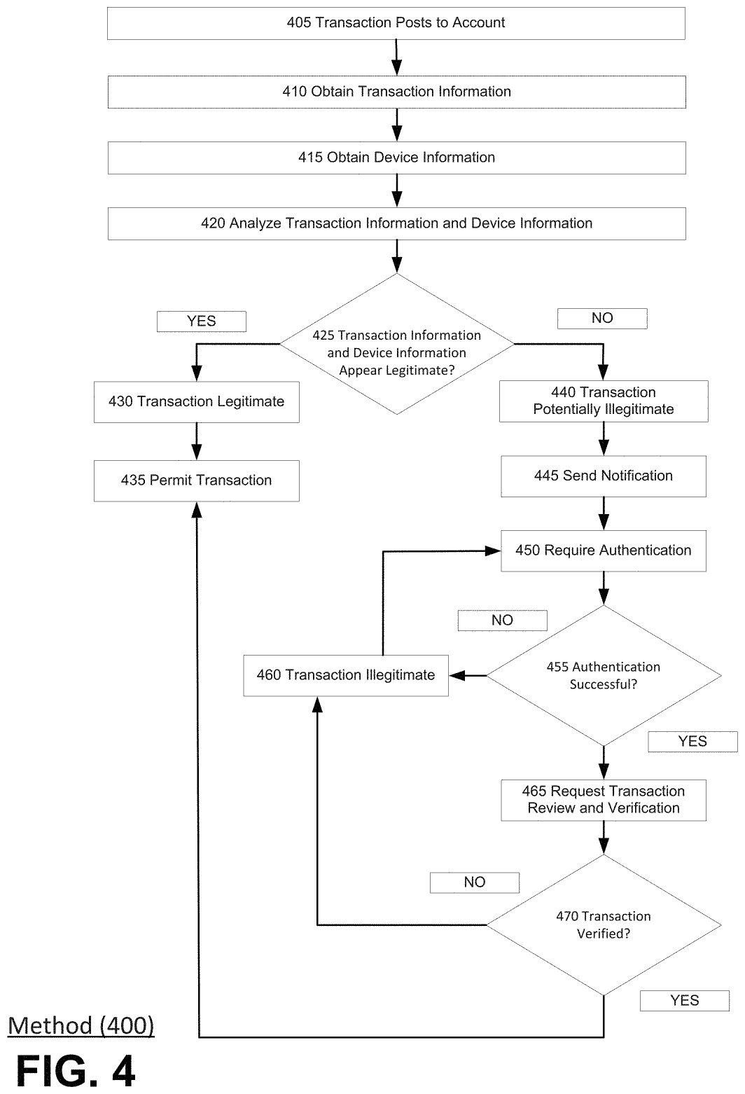

FIG. 4 illustrates a method of verifying a transaction according to an example embodiment. The method 400 commences in step 405, where a transaction posts to an account associated with a user that is being monitored by the tracking application. The tracking application can monitor the account and detect the transaction, or the tracking application can receive notifications when transactions involving the monitored account occur. The tracking application can be stored and executed from a remote location, such as a server, or can be stored and executed from a client device associate with the user's account. In either case, it is understood that the tracking application can be in data communication with user information and transaction databases necessary to monitor account and access device information and movement profiles in order to perform the functions described herein.

Upon recognition of a transaction involving the monitored account, the method can proceed to steps 410 and 415 where the tracking application can obtain the information for its analysis. During step 410, the tracking application can obtain the transaction information for the transaction that has occurred. The transaction information can include information relating to the transaction, e.g., goods or services purchased, purchase location, purchase time, payment amount, and method of payment. The transaction information can further include any device information collected by the third party point-of-sale device or devices involved in the transactions. The third party-point-of-sale and For example, if the third party-point-of-sale device contains any device components, the device information collected by these components can be provided for analysis and potential inclusion in one or more movement profiles. Further, the third party point-of-sale device may make information available to the client device or other device involved in the transaction.

In an embodiment, the transaction information collected in step 410 can further include transaction information covering similar, related, or duplicative transactions, which took place prior to the transaction. The transaction information can be taken from transactions involving an account (or accounts) associated with the user, or accounts associated with other users. In addition, the transaction information can include device information measured at the time of the previous transactions, from client devices(s) associated with the user or with other users.

In step 415, the tracking application can collect the device information from the client device associated with the user at the time of the transaction, and also at times before and after the transaction, if available. It is understood steps 410 and 415 are not limited to a specific order, and one step can be performed before or after, or simultaneously with, the other.

Once steps 410 and 415 are completed, the method can proceed to step 420, where the tracking application can analyze the collected transaction information and device information. As previously described, the tracking application can analyze the transaction information and device information for legitimacy. In doing so, the tracking application can analyze the device information alone and compare the device information to the transaction information, in order to determine consistency and identify any indications that the transaction may be unauthorized, potentially fraudulent, or otherwise illegitimate. In step 425, the an analysis can be performed to determine whether the transaction is legitimate or potentially illegitimate such that verification is required. In some examples, this analysis to determine the potential illegitimacy of a transaction can be performed by the tracking application itself by determining whether the device information is consistent with a movement profile. In other examples, the tracking application can determine whether the device information is consistent with a movement profile, and if the tracking application finds that the device information is inconsistent with the movement profile, the tracking application can send an indication of potential illegitimacy to a fraud assessment authority, such as a fraud analysis algorithm or a fraud investigation department, for further investigation and to determine whether the transaction is likely fraudulent. Regardless of the analysis performed, if the analysis results in a determination that the transaction is legitimate, the method can proceed to steps 430 and 435 where the transaction can be deemed legitimate and the transaction is permitted without requiring further authorization or verification.

If in step 425 the analysis results in a determination that there is at least some indication that the transaction could be unauthorized, potentially fraudulent, or otherwise illegitimate, the method can proceed to step 440 where the transaction can be deemed potentially illegitimate. Then, in step 445, a notification can be sent to the client device or other means of communication associated with the user for further investigation of this transaction. The notification can present a requirement for the user to authenticate himself or herself prior to reviewing the transaction (step 455). If the user is not successfully authenticated, or does not complete the authentication process within a certain period of time, the method can proceed to step 460 and the transaction can be deemed illegitimate. At this point, the transaction can be denied, rescinded, or submitted to an investigative authority for further review.

If the user successfully completes the authentication required in step 455, the method can proceed to step 465, where a request for review and verification of the transaction can be sent. In an embodiment, an affirmative verification can be required from the user, and the transaction can be deemed illegitimate if the affirmative verification is not received, or not received in time. Alternatively, the notification can request the user review the transaction and respond to the notification only if the user considers the transaction illegitimate. If, during step 470, the user verifies the transaction as legitimate, the method can proceed to step 435 where the transaction can be deemed legitimate. However, if during step 470 the user responds that the transaction is illegitimate, or does not complete the verification within a certain period of time, the method can proceed to step 460 and the transaction can be deemed illegitimate.

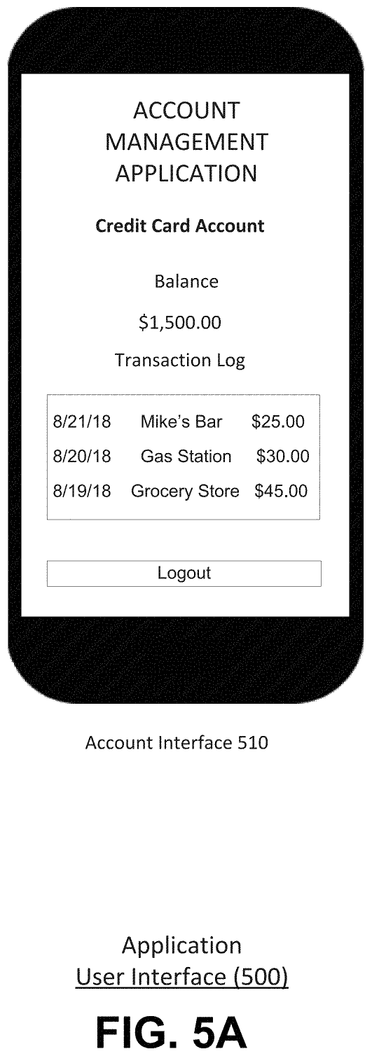

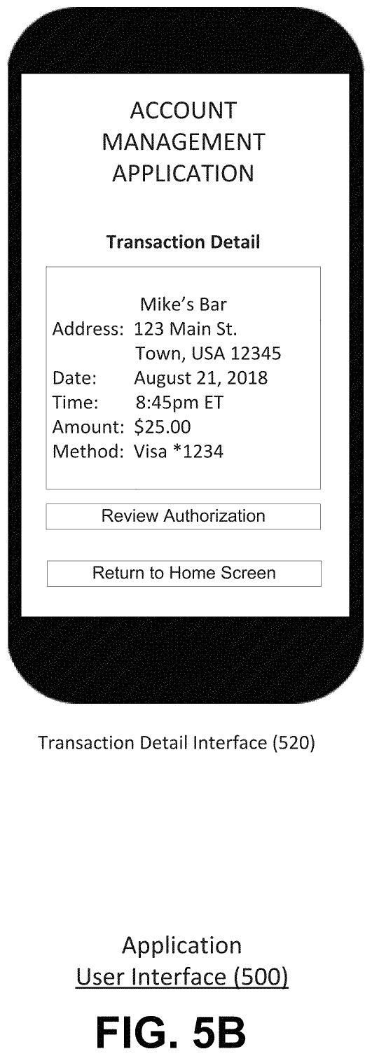

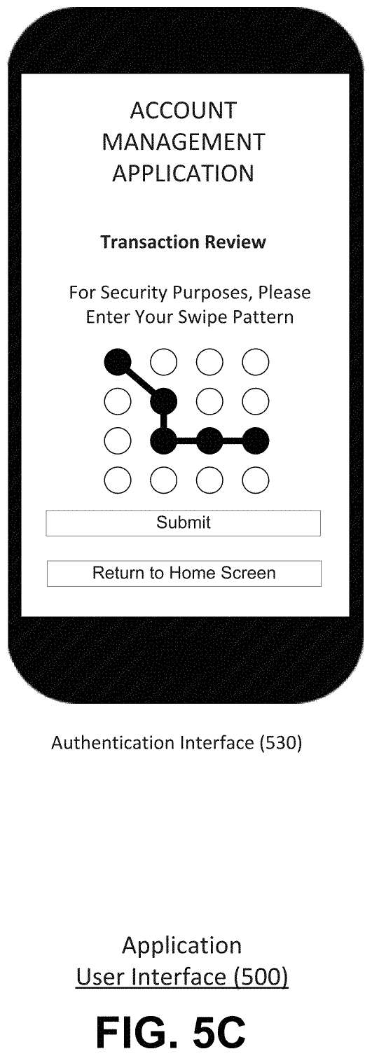

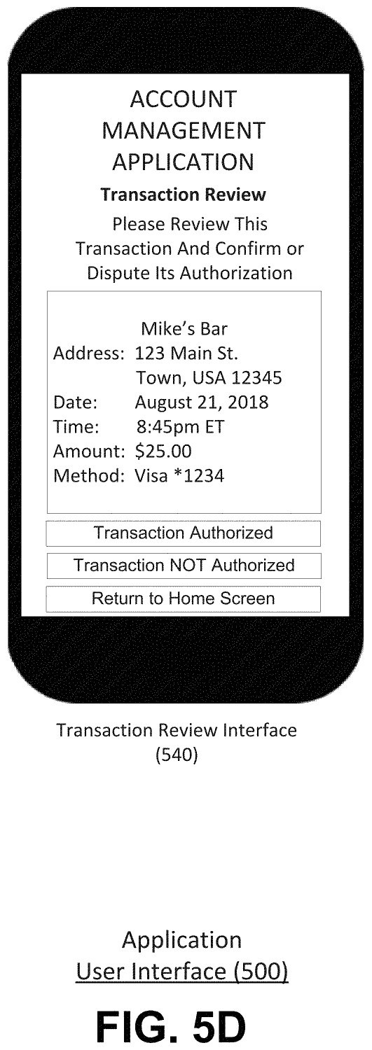

FIGS. 5A-5E illustrate a series of application user interfaces of a user's client device according to example embodiments. In an embodiment, the application user interfaces can be displayed by the tracking application. Alternatively, the application user interfaces can be displayed by a separate application in data communication with the tracking application. The application user interface 500 shown in these figures may be displayed on a smartphone, tablet computer, laptop computer, desktop computer, or any other client device where an account management application has been installed or can be deployed. In an embodiment, the application user interface 500 may be adapted to a mobile client device, including a smart phone and a tablet computer. In another embodiment, the application user interface 500 may be adapted to a client device with more system resources, including a laptop computer or desktop computer.

As shown in FIG. 5A, the application user interface 500 can present an account interface 510 on the display of the user's client device. The account interface 510 can allow the user to access account information such as account balance and a transaction log.

FIG. 5B shows a transaction detail interface 520, which can be displayed when the user chooses to view the details of a specific transaction. The transaction detail interface 520 can display details for this transaction, including without limitation, merchant name, merchant location, transaction date, transaction time, transaction amount, and payment. It is understood that the transaction details displayed in transaction detail interface 520 are not a representation of the entirety of the transaction information available to the tracking application. In an embodiment, the transaction details can be drawn from the transaction information available to the tracking application. In addition, the transaction detail interface 520 can permit the user to initiate a transaction review of a potentially unauthorized transaction. If selected, this option can lead the user to the authentication interface 530 or the transaction review interface 540, depending upon the configuration of the account management application.

FIG. 5C shows an authentication interface 530, which can be displayed as part of an initiated transaction review procedure. The user can be required to authenticate himself or herself prior to reviewing a transaction. Authentication interface 530 depicts a swipe pattern as a form of authentication, but it is understood that the authentication procedure can involve one or more authentication procedures supported by the client device, including without limitation entering a username, entering a password, entering an access code, answering a security question, swiping a pattern, image recognition, identification scans (e.g., driver's license scan and passport scan), device registrations, telephone numbers, email addresses, social media account access information, multi-factor authentication, and biometric identification (e.g., voice recognition, fingerprint scans, retina scans, and facial scans). Upon successful authentication, the transaction review interface 540 can be displayed.

FIG. 5D shows a transaction review interface 540, which can be displayed for the user to review a transaction. The transaction review interface 540 includes transaction details and presents the user with the option of reporting the transaction as authorized or unauthorized. If the user reports the transaction as authorized, the transaction can be considered legitimate by the tracking application. If the user reports the transaction as unauthorized, the tracking application can consider the transaction illegitimate.

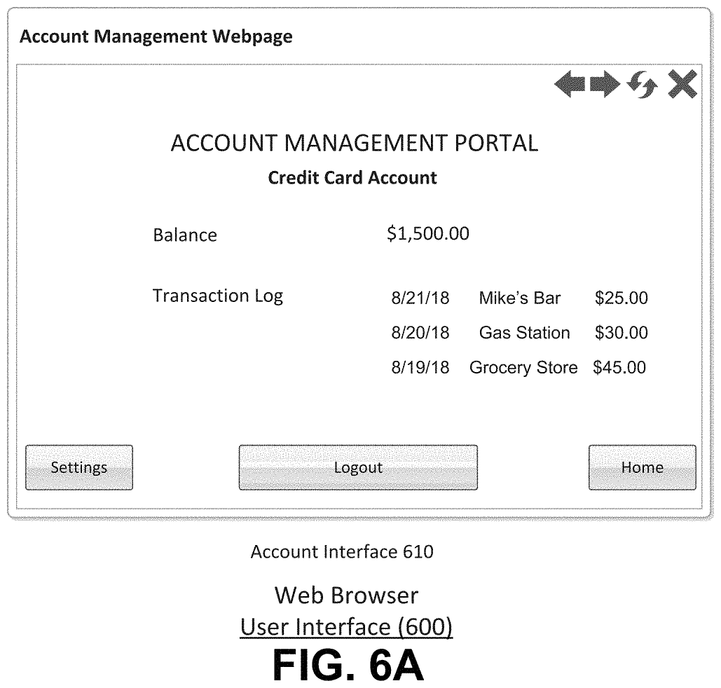

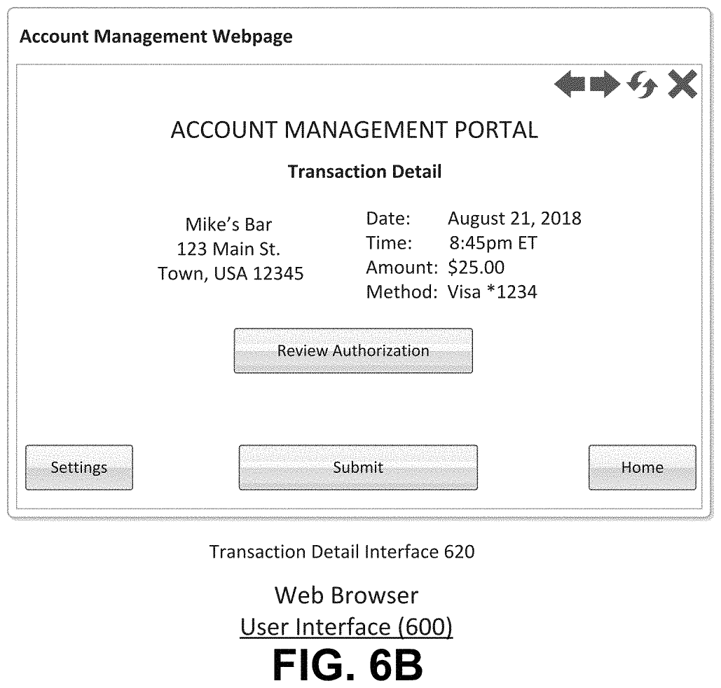

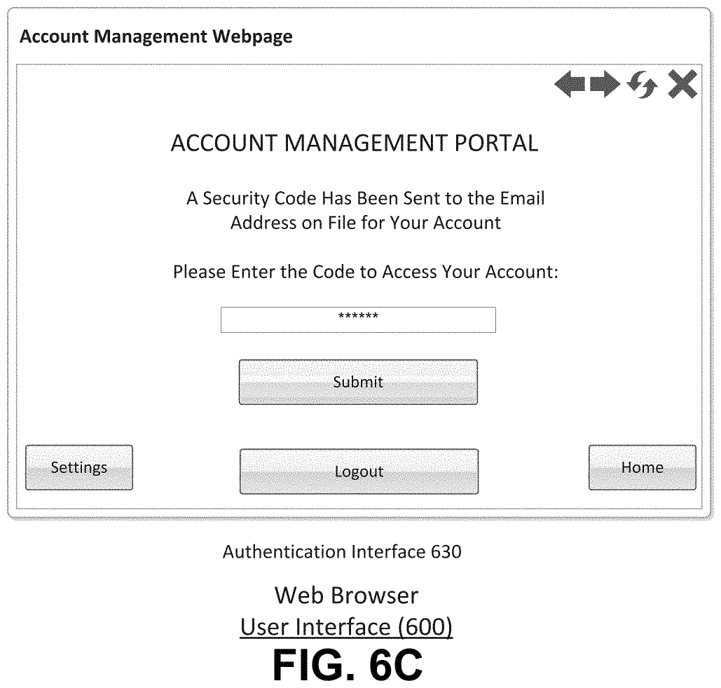

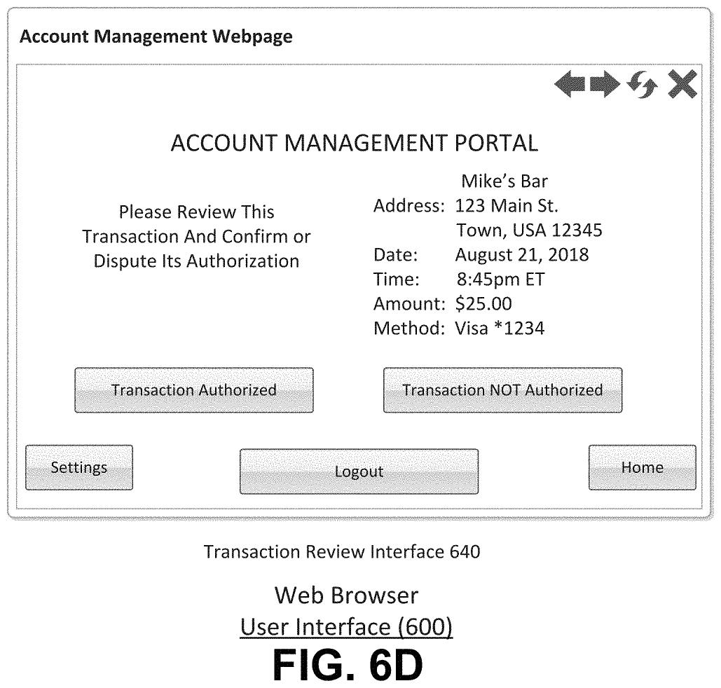

FIGS. 6A-6E illustrate a series of web browser user interfaces of a user's client device according to example embodiments. The web browser user interface 600 shown in these figures may be displayed on a smartphone, tablet computer, laptop computer, desktop computer, or any other client device where a web browser has been installed or can be deployed. In an embodiment, the web browser user interface 600 may be adapted to a mobile client device, including a smart phone and a tablet computer. In another embodiment, the web browser user interface 300 may be adapted to a client device with more system resources, including a laptop computer or desktop computer.

As shown in FIG. 6A, the web browser user interface 600 can present an account interface 610 on the display of the user's client device. The account interface 610 can allow the user to access account information such as account balance and a transaction log.

FIG. 6B shows a transaction detail interface 620, which can be displayed when the user chooses to view the details of a specific transaction. The transaction detail interface 620 can display details for this transaction, including without limitation, merchant name, merchant location, transaction date, transaction time, transaction amount, and payment. It is understood that the transaction details displayed in transaction detail interface 620 are not a representation of the entirety of the transaction information available to the tracking application. In an embodiment, the transaction details can be drawn from the transaction information available to the tracking application. In addition, the transaction detail interface 620 can permit the user to initiate a transaction review of a potentially unauthorized transaction. If selected, this option can lead the user to the authentication interface 630 or the transaction review interface 640, depending upon the configuration of the account management web site.

FIG. 6C shows an authentication interface 630, which can be displayed as part of an initiated transaction review procedure. The user can be required to authenticate himself or herself prior to reviewing a transaction. Authentication interface 630 depicts a swipe pattern as a form of authentication, but it is understood that the authentication procedure can involve one or more authentication procedures supported by the client device, including without limitation entering a username, entering a password, entering an access code, answering a security question, swiping a pattern, image recognition, identification scans (e.g., driver's license scan and passport scan), device registrations, telephone numbers, email addresses, social media account access information, multi-factor authentication, and biometric identification (e.g., voice recognition, fingerprint scans, retina scans, and facial scans). Upon successful authentication, the transaction review interface 640 can be displayed.

FIG. 6D shows a transaction review interface 640, which can be displayed for the user to review a transaction. The transaction review interface 640 includes transaction details and presents the user with the option of reporting the transaction as authorized or unauthorized. If the user reports the transaction as authorized, the transaction can be considered legitimate by the tracking application. If the user reports the transaction as unauthorized, the tracking application can consider the transaction illegitimate.

As described herein, account monitoring and transaction verification are complex and critical operations, which can incur significant financial and system resources to properly perform, and high risks for the failure to properly perform these operations. Embodiments of the present disclosure provide systems and methods for account monitoring and transaction verification that reduce these costs and risks, and improve efficiency, ease of user access, and account security while integrating with monitoring applications and administrative operations.

In addition, embodiments of the present disclosure perform account monitoring and transaction verification without reliance on location tracking. Location tracking can have significant limitations as a tool for fraud detection. For example, location tracking can be turned on or off by the user due to legitimate privacy concerns or to reduce the effectiveness of a fraud detection tool. As another example, location tracking technology can have limited effectiveness in certain instances, such as when a GPS signal can be lost indoors, in rural areas, in situations where a clear view of the sky is obstructed, and in other instances. In contrast, use of the device components and movement profiles as described herein, without utilizing location tracking, can provide more reliable and more robust monitoring and verification that is more difficult for users to circumvent or disable.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

1. A transaction monitoring system, comprising:
a server containing a user account database storing transaction information associated with at least one account;
an application configured to obtain device information from a client device;
a processor configured to, upon receipt of a communication based on activity associated with the at least one account:
access the device information from the application, the device information including movement data of the client device over a predetermined period of time before receipt of the communication and movement data of the client device over a predetermined period of time after the activity associated with the at least one account;
retrieve the transaction information relating to the activity associated with the at least one account;
compare the transaction information to the device information to identify at least one discrepancy between the transaction information and the movement data; and
generate a notification based on the at least one discrepancy;
wherein the movement data includes data from at least one selected from the group of a gyroscope, an accelerometer, a pedometer, a magnetometer, a linear acceleration sensor, and an attitude sensor to determine a location of the client device, and wherein the movement data excludes Global Positioning System (GPS) data;
wherein generation of the notification requires receipt by the processor of a confirmation signal indicating user authorization of a transaction, and
wherein the notification includes associated confirmation data specifying a time period for receipt of the confirmation signal by the processor.

2. The transaction monitoring system of claim 1, wherein:
the device information includes the strength of a cellular signal available to the client device, and
the movement data of the client device further includes at least one selected from the group of an acceleration of the client device and a rotational motion of the client device.

3. The transaction monitoring system of claim 1, wherein the movement data further includes data from a transmitter.

4. The transaction monitoring system of claim 3, wherein the movement data is aggregated into a movement profile containing device information from a plurality of client devices.

5. (canceled)

6. The transaction monitoring system of claim 1, wherein the transaction information includes device information and one or more at least one selected from the group of purchase history, purchase time, purchase amount, goods or services purchased, purchase location, and purchaser identification.

7. The transaction monitoring system of claim 6, wherein the at least one discrepancy is identified by comparing the device information to patterns of device information contained in the transaction information.

8. The transaction monitoring system of claim 1, wherein the notification is sent to one or more of the application, an email address associated with a user, a phone number associated with the user, and a second client device associated with the user.

9. (canceled)

10. The transaction monitoring system of claim 1, wherein the transaction is classified as potentially fraudulent unless the server receives confirmation that the transaction was authorized within the time period, and wherein upon classification of the transaction as potentially fraudulent, the notification and the least one discrepancy are recorded in a fraudulent activity report database.

11. A method of monitoring transactions, the method comprising:
recognizing a transaction involving an account associated with a user, the transaction having details of the transaction;
obtaining device information from a client device associated with the user, the device information including movement data of the client device for a predetermined period of time prior to the transaction and for a predetermined period of time after the transaction;
executing a query of a transaction database to obtain transaction information relating to previous transactions, wherein the query is based at least in part on the details of the transaction;
comparing the transaction information to the device information and a movement profile and identifying at least one discrepancy between the transaction information and the device information and the movement profile;
sending a notification to the client device requesting classification of the transaction as authorized or unauthorized;
wherein the movement data of the client device includes data from at least one selected from the group of a gyroscope, an accelerometer, a pedometer, a magnetometer, a linear acceleration sensor, and an attitude sensor to determine a location of the client device and excludes Global Positioning System (GPS) data.

12. The method of monitoring transactions of claim 11, the method further comprising:
receiving the classification of the transaction as unauthorized; and
storing information relating to the transaction and the at least one discrepancy to a fraudulent activity report database.

13. The method of monitoring transactions of claim 11, wherein the notification requires submission of authentication information prior to classification of the transaction, wherein the authentication information includes at least one selected from the group of a password, an access code, a swipe pattern, a security question, and a form of biometric identification.

14. The method of monitoring transactions of claim 13, further comprising classifying the transaction as unauthorized if the authorization is not received within a predetermined period.

15. The method of monitoring transactions of claim 11, wherein the movement profile includes device information relating to a plurality of transactions involving one or more accounts associated with the user.

16. The method of monitoring transactions of claim 11, wherein the movement profile includes device information relating to a plurality of transactions involving one or more accounts not associated with the user.

17. (canceled)

18. (canceled)

19. The method of monitoring transactions of claim 11, wherein:
the movement data of the client device is obtained by an application installed on the client device, and
the movement data of the client device includes at least one selected from the group of an acceleration of the client device and rotational motion of the client device.

20. An apparatus comprising:
a client device associated with a user, the client device including memory storing an account monitoring application including instructions to be executed by the client device, the application configured to:
access account data relating to an account associated with the user;
determine whether a transaction involving the account has taken place; and
upon determining that a transaction involving the account has taken place:
collect device information from at least one selected from the group of a gyroscope, an accelerometer, a pedometer, a magnetometer, a linear acceleration sensor, and an attitude sensor on the client device to determine a location of the client device, the device information including movement data of the client device for a predetermined period of time prior to the transaction and for a predetermined period of time after the transaction, wherein the device information excludes Global Positioning System (GPS) data;
send the device information and account data to a server;
display a request for classification of the transaction as authorized or unauthorized; and
notify the server of the classification.
